(19) United States
(12) Patent Application Publication
(10) Pub. No.: US 2015/0295737 A1
(43) Pub. Date: Oct. 15, 2015

(54) SOFT DECISION DETECTING METHOD AND APPARATUS OF MULTIPLE-INPUT MULTIPLE-OUTPUT COMMUNICATION SYSTEM

(71) Applicant: Electronics and Telecommunications Research Institute, Daejeon (KR)

(72) Inventors: Young Min KIM, Daejeon (KR); Jae Hyun SEO, Daejeon (KR); Heung Mook KIM, Daejeon (KR)

(21) Appl. No.: 14/642,076

(22) Filed: Mar. 9, 2015

(30) Foreign Application Priority Data
Apr. 9, 2014 (KR) 10-2014-0042578

(51) Int. Cl. H04L 25/03; H04L 1/00; H04B 7/04

(52) U.S. Cl. CPC H04L 25/03318; H04B 7/0413; H04L 1/0054

(57) ABSTRACT

A soft decision detecting device in a multiple-input multiple-output (MIMO) receiving apparatus detects reception symbols from signals received through a plurality of reception antennas, calculates a variance of interference and noise of the detected reception symbols, and soft-decision-demaps the detected reception symbols by using the variance of interference and noise of the detected reception symbols to thus calculate a soft decision value.

### CROSS-REFERENCE TO RELATED APPLICATION

This application claims priority to and the benefit of Korean Patent Application No. 10-2014-0042578 filed in the Korean Intellectual Property Office on Apr. 9, 2014, the entire contents of which are incorporated herein by reference.

### BACKGROUND OF THE INVENTION

(a) Field of the Invention

The present invention relates to a soft decision detecting method and device of a multiple-input multiple-output communication system.

(b) Description of the Related Art

Recently, in order to overcome channel degradation occurring in data transmission, a forward error correction (FEC) code has been used. Some FEC codes employ a scheme of repeatedly performing decoding by using a soft decision value, and thus a receiver of a system using MIMO antennas needs to provide an accurate soft decision value in a MIMO detection stage. A maximum likelihood detection (MLD) scheme should be used to obtain maximum performance according to the request of the receiver. However, an exponential increase in complexity due to the number of antennas and modulation order makes it difficult to realize an actual system. Thus, a detection method having linear complexity such as zero forcing (ZF) or minimum mean square error (MMSE), or a method such as ordered-successive interference cancellation (O-SIC), needs to be used.

### SUMMARY OF THE INVENTION

The present invention has been made in an effort to provide a soft decision detecting method and device of a multiple-input multiple-output (MIMO) communication system having advantages of detecting a soft decision value with low complexity.

An exemplary embodiment of the present invention provides a soft decision detecting method in a MIMO receiving apparatus. The soft decision detecting method may include: receiving symbols, transmitted through a plurality of transmission antennas, by a plurality of reception antennas; detecting each reception symbol from signals received through the plurality of reception antennas; calculating a variance of interference and noise of the detected reception symbols; and soft-decision-demapping the detected reception symbols by using the variance of interference and noise of the detected reception symbols.

The detecting may include first detecting symbols by using one among zero forcing (ZF), minimum mean square error (MMSE), and successive interference cancelation (SIC) schemes.

The detecting may include detecting the reception symbols by dividing the first detected symbols by a corresponding channel gain.

The soft-decision-demapping may include calculating a soft decision value with respect to the detected reception symbols by using a maximum likelihood detection (MLD) scheme.

The soft-decision-demapping may include calculating a soft decision value with respect to the detected reception symbols by using a max log map scheme.

The soft-decision-demapping may include calculating soft decision values with respect to the detected reception symbols by using a hard decision boundary.

Another embodiment of the present invention provides a soft decision detecting device in a multiple-input multiple-output (MIMO) receiving apparatus.

The soft decision detecting device may include a MIMO demodulation unit and a demapper. The MIMO demodulation unit may detect reception symbols from signals received through a plurality of reception antennas and calculate a variance of interference and noise of the detected reception symbols. The demapper may soft-decision-demap the detected reception symbols by using the variance of interference and noise of the detected reception symbols.

The MIMO demodulation unit may use one among zero forcing (ZF), minimum mean square error (MMSE), and successive interference cancelation (SIC) schemes.

The MIMO demodulation unit may detect the reception symbols by dividing the symbols detected by the one detection scheme, by a channel gain.

The demapper performs soft-decision-demapping by using one among a maximum likelihood detection (MLD) scheme, a maximum log map scheme, and a scheme using a hard decision boundary.

### BRIEF DESCRIPTION OF THE DRAWINGS

FIG. 1 is a view illustrating an example of a MIMO communication system according to an exemplary embodiment of the present invention.

FIG. 2 is a flowchart illustrating a transmission method of a MIMO transmitting apparatus illustrated in FIG. 1.

FIG. 3 is a flowchart illustrating a reception method of a MIMO receiving apparatus illustrated in FIG. 1.

FIG. 4 is a view illustrating a soft decision detecting device according to an exemplary embodiment of the present invention.

FIG. 5 is a flowchart illustrating a soft decision detecting method according to an exemplary embodiment of the present invention.

FIG. 6 is a view illustrating bit error rate (BER) performance when the soft decision detecting method according to an exemplary embodiment of the present invention is used.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and claims, unless explicitly described to the contrary, the word “comprise” and variations such as “comprises” or “comprising” will be understood to imply the inclusion of stated elements but not the exclusion of any other elements.

Hereinafter, a soft decision detecting method and apparatus of a MIMO communication system according to an exemplary embodiment of the present invention will be described in detail with reference to the accompanying drawings.

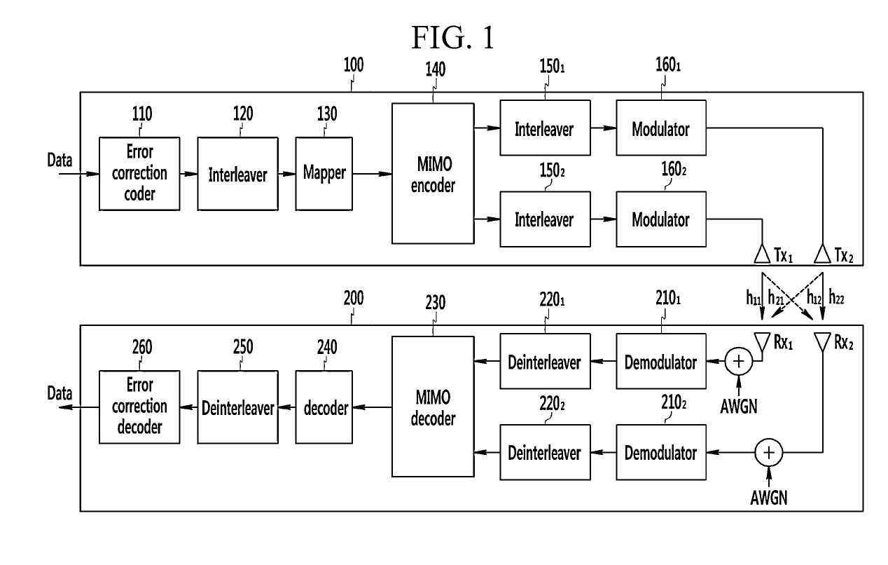

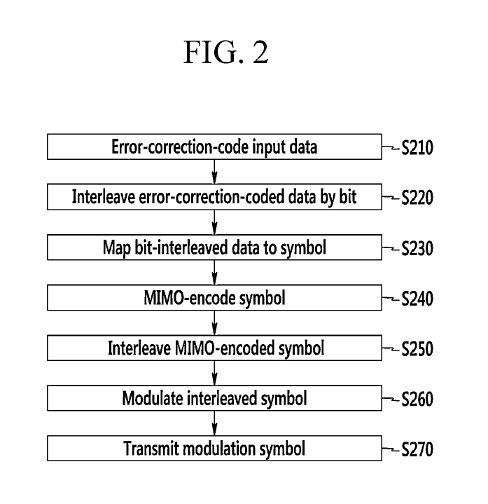

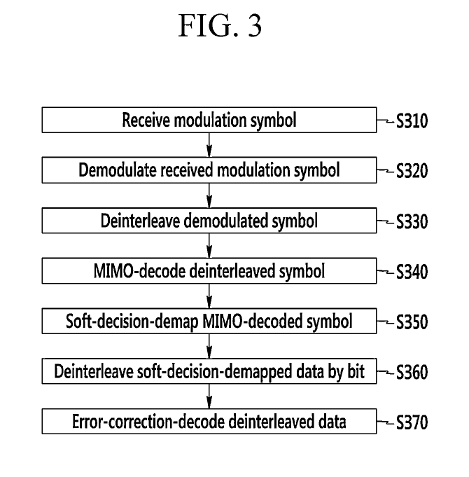

FIG. 1 is a view illustrating an example of a MIMO communication system according to an exemplary embodiment of the present invention. FIG. 2 is a flowchart illustrating a transmission method of a MIMO transmitting apparatus illustrated in FIG. 1, and FIG. 3 is a flowchart illustrating a reception method of a MIMO receiving apparatus illustrated in FIG. 1.

Referring to FIG. 1, the MIMO communication system includes a MIMO transmitting apparatus 100 and a MIMO receiving apparatus 200.

The MIMO transmitting apparatus 100 includes an error correction coder 110, an interleaver 120, a mapper 130, a MIMO encoder 140, a plurality of interleavers 150₁-150_{N}, a plurality of modulators 160₁-160_{N}, and a plurality of transmission antennas Tx₁-Tx_{N}.

The MIMO receiving apparatus 200 includes a plurality of reception antennas Rx₁-Rx_{N}, a plurality of demodulators 210₁-210_{N}, a plurality of deinterleavers 220₁-220_{N}, a MIMO decoder 230, a demapper 240, a deinterleaver 250, and an error correction decoder 260.

In FIG. 1, it is illustrated that N=2 for the purposes of description.

Referring to FIG. 2, the error correction coder 110 error-correction-codes input data (S210). That is, the error correction coder 110 generates an error correction parity bit for input data, adds the error correction parity bit to the input data, and outputs the same.

The interleaver 120 interleaves the error-correction-coded data by bits (S220).

The mapper 130 maps the bit-interleaved data to symbols (S230). For the mapping, a method such as QAM, VSB, or APSK may be used.

The MIMO encoder 140 performs MIMO encoding on the symbols (S240). The MIMO encoding includes a spatial multiplexing scheme and a spatial diversity scheme. The spatial multiplexing is a scheme of simultaneously transmitting different data from a plurality of transmission antennas Tx₁-Tx_{N}, thereby transmitting high speed data without increasing a bandwidth of the system.

The plurality of interleavers 150₁-150_{N} interleave the MIMO-encoded symbols, respectively (S250). For the interleaving scheme, at least one among symbol, time, and frequency interleaving may be used.

The plurality of modulators 160₁-160_{N} modulate the interleaved symbols from the plurality of interleavers 150₁-150_{N} according to a preset modulation scheme to generate modulation symbols (S260), and deliver the modulation symbols to corresponding transmission antennas, respectively. As the modulation scheme, binary phase shift keying (BPSK), quadrature phase shift keying (QPSK), quadrature amplitude modulation (QAM), pulse amplitude modulation (PAM), phase shift keying (PSK), and the like may be used.

The plurality of transmission antennas Tx₁-Tx_{N} transmit the modulation symbols which have been respectively generated by the modulators 160₁-160_{N} (S270).

Referring to FIG. 3, the plurality of reception antennas Rx₁-Rx_{N} receive the modulation symbols transmitted from the MIMO transmitting apparatus 100 (S310).

The plurality of demodulators 210₁-210_{N} respectively demodulate the modulation symbols received through the plurality of antennas Rx₁-Rx_{N} according to a preset demodulation scheme (S320). The demodulation scheme may correspond to the modulation scheme of the MIMO transmitting apparatus 100.

The plurality of deinterleavers 220₁-220_{N} respectively deinterleave the symbols which have been demodulated by the plurality of demodulators 210₁-210_{N} (S330). The deinterleaving scheme may correspond to the interleaving of the MIMO transmitting apparatus 100, and at least one among symbol, time, and frequency deinterleaving may be used.

The MIMO decoder 230 MIMO-decodes the symbols respectively deinterleaved by the plurality of deinterleavers 220₁-220_{N} and delivers the decoded symbols to the demapper 240 (S340). As the MIMO decoding scheme, the MIMO decoder 230 uses zero forcing (ZF), minimum mean square error (MMSE), successive interference cancelation (SIC), and the like, and here, the MIMO decoder 230 calculates a noise variance value that is varied for each decoded symbol and delivers the calculated noise variance value to the demapper 240. That is, the MIMO decoder 230 MIMO-decodes the symbols that are respectively deinterleaved by the plurality of deinterleavers 220₁-220_{N} to generate mutually independent symbols. The generated symbols are delivered to the demapper 240.

The demapper 240 performs soft decision demapping on the MIMO-decoded symbols to bits (S350). The demapper 240 demaps the MIMO-decoded symbols by using the noise variance value delivered from the MIMO decoder 230.

The deinterleaver 250 deinterleaves the soft decision-demapped bit data by bits (S360).

The error correction decoder 260 error-correction-decodes the deinterleaved data and outputs the decoded data (S370).

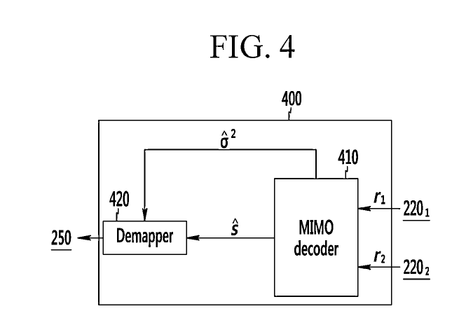

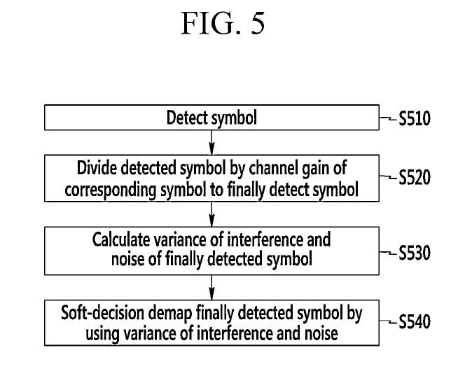

Hereinafter, the soft decision detection method in the MIMO receiving apparatus 200 according to an exemplary embodiment of the present invention will be described in detail with reference to FIGS. 4 and 5.

FIG. 4 is a view illustrating a soft decision detecting device according to an exemplary embodiment of the present invention, and FIG. 5 is a flowchart illustrating a soft decision detecting method according to an exemplary embodiment of the present invention.

Referring to FIG. 4, the soft decision detecting device 400 includes a MIMO decoder 410 and a demapper 420. The MIMO decoder 410 and the demapper 420 may be the MIMO decoder 230 and the demapper 240 of the MIMO receiving apparatus of FIG. 1.

When a number N_{T} of transmission antennas and a number N_{R} of reception antennas are provided, symbols received from the MIMO receiving apparatus 200 may be expressed as Equation 1 below.

$$y = Hs + n = [ \begin{matrix}{h}_{11} & {h}_{12} & … & {h}_{1 {N}_{T}} \\ {h}_{21} & {h}_{22} & … & {h}_{2 {N}_{T}} \\ … & … & … & … \\ {h}_{{N}_{R} 1} & {h}_{{N}_{R} 2} & … & {h}_{{N}_{R} {N}_{T}}\end{matrix} ] [ \begin{matrix}{s}_{1} \\ {s}_{2} \\ … \\ {s}_{i}\end{matrix} ] + [ \begin{matrix}{n}_{1} \\ {n}_{2} \\ … \\ {n}_{i}\end{matrix} ] \qquad ( Equation 1 )$$

In Equation (1), hᵢⱼ is a channel coefficient between a j-th transmission antenna and an i-th reception antenna, y is a reception symbol vector having a magnitude of N_{R}×1, s is a transmission symbol vector having a magnitude of N_{T}×1, and n is a Gaussian noise vector having a magnitude of N_{R}×1.

Maximum likelihood detection (MLD) is a method for detecting a received symbol y. In the MLD scheme, distances are calculated for every symbol that can be combined with the received symbol y, and thus, complexity increases exponentially.

For example, when the MIMO transmitting apparatus of the communication system using 2×2 transmission/reception antennas uses a 256 QAM scheme, the soft decision detecting device 400 should perform an exp operation 2^{2×6} (=65,536) times to detect reception symbols, so it is impossible to realize a system. Due to this problem, a maximum log map scheme has been developed, but this scheme should search for a maximum value, causing difficulty in implementation.

Referring to FIG. 5, the MIMO decoder 410 of the soft decision detecting device 400 according to an exemplary embodiment of the present invention first detects symbols according to a method such as ZF, MMSE, or SIC (S510). The detected symbol may be expressed as Equation 2 below.

s̅=Gr (Equation 2)

Here, s̅ is a symbol vector detected by matrix G. For example, when the ZF detection scheme is used, a detection matrix G=(H^{H}H)⁻¹H^{H}, and when the MMSE detection scheme is used, the detection matrix G=(H^{H}N+1/(SNR)I)⁻¹H^{H}.

The MIMO decoder 410 divides the detected i-th symbol by a channel gain of the detected symbol to finally detect the i-th symbol (S520).

$$\begin{matrix}{s}_{i}^{′} = \frac{{\hat{s}}_{i}}{{g}_{ii} {h}_{ii}} \\ = {s}_{i} + {\sum }_{j = 1 ( j \neq i )}^{{N}_{T}} \frac{{g}_{ij} {h}_{ij}}{{g}_{ii} {h}_{ii}} {s}_{j} + {\sum }_{j = 1}^{{N}_{T}} \frac{{g}_{ij}}{{g}_{ii} {h}_{ii}} {n}_{j}\end{matrix} \qquad ( Equation 3 )$$

In Equation 3, gᵢⱼ is a coefficient of an i-th row and a j-th column.

In the symbol sᵢ′ detected by Equation 3, the remainder, excluding sᵢ, is interference and noise, and the MIMO decoder 410 calculates variance of interference and noise of the detected symbol expressed as Equation 4 (S530).

$$\begin{matrix}{\hat{σ}}_{i}^{2} = VAR [ {\sum }_{j = 1 ( j \neq i )}^{{N}_{t}} \frac{{g}_{ij} {h}_{ij}}{{g}_{ii} {h}_{ii}} {s}_{j} + {\sum }_{j = 1}^{{N}_{t}} \frac{{g}_{ij} {n}_{j}}{{g}_{ii} {h}_{ii}} ] , \\ = \frac{{\sum }_{j = 1 ( j \neq i )}^{{N}_{t}} {‖ {g}_{ij} {h}_{ij} ‖}^{2} + {\sum }_{j = 1}^{{N}_{t}} {‖ {g}_{ij} ‖}^{2} {σ}_{j}^{2}}{{‖ {g}_{ii} {h}_{ii} ‖}^{2}}\end{matrix} \qquad ( Equation 4 )$$

The MIMO decoder 410 delivers the symbol sᵢ′ detected by Equation 5 and the variance value of the interference and noise calculated by Equation 4 to the demapper 420.

The demapper 420 soft-decision-demaps the symbol detected by the MIMO decoder 410 by using the variance value of interference and noise (S540). As the soft decision demapping method by the demapper 420, the MLD scheme and the max-log MAP scheme may be used for each symbol detected by the MIMO decoder 410. Also, a soft decision detecting method using a simpler hard decision boundary may be used as a soft decision demapping method.

When the symbol detected by the MIMO decoder 410 is soft-decision-demapped according to the MLD scheme by the demapper 420, complexity can be significantly reduced, compared with the conventional use of the MLD scheme in the MIMO decoder 410.

As described above, in the case where the MIMO transmitting apparatus of the communication system using 2×2 transmission/reception antennas uses the 256 QAM scheme, when the MIMO decoder 410 of the MIMO receiving apparatus uses the MLD scheme, the exp operation should be performed 65,536 times to detect two symbols. In contrast, in the exemplary embodiment of the present invention, the demapper 420 needs only to soft-decision-demap the MLD on the two symbols independently detected by the MIMO decoder 410 of the MIMO receiving apparatus, and the exp operation may need to be executed only 512 (2×2⁸=512) times.

Also, when the demapper 420 performs soft-decision demapping using a hard decision boundary, the exp operation is not required.

Table 1 shows calculation complexity when the MIMO decoder 410 uses the MLD scheme and when the demapper 420 uses the MLD scheme, the maximum log map scheme, and the scheme of using a hard decision boundary for a symbol detected by the MIMO decoder 410 as in the exemplary embodiment of the present invention.

TABLE 1

| | | | Soft decision demapping method | | |
|---|---|---|---|---|---|
| | | | according to exemplary embodiment | | |
| | | | of the present invention | | |
| | | | | | Demapping |
| | | | | Max log | using hard |
| | | Existing | MLD | map | decision |
| | | MLD | demapping | demapping | boundary |
| 2 × 2 transmission/ | Exp (times) | 2^{2×8} = 65526 | 2 × 2⁸ = 256 | 2 × 2⁸ = 256 | 0 |
| reception | Log (times) | 2 × 2 = 4 | 2 × 2 = 4 | 2 × 2 = 4 | 0 |
| antennas | | | | | |
| (2 symbols are | | | | | |
| detected) | | | | | |

As illustrated in Table 1, it can be seen that, when the demapper 420 uses the MLD scheme, the maximum log map scheme, and the scheme of using a hard decision boundary for the symbols detected by the MIMO decoder 410, calculation complexity is considerably reduced.

For example, the MIMO decoder 410 may use the ZF detection scheme, and the demapper 420 may use the MLD demapping scheme.

When the MIMO decoder 410 uses the ZF detection scheme, a symbol may be detected as expressed by Equation 5.

s̅=(H^{H}H)⁻¹H^{H}r (Equation 5)

When the MIMO decoder 410 uses the ZF detection scheme, a channel gain of symbol s̅ is 1 and interference is 0.

When H̅=(H^{H}H)⁻¹H^{H} in Equation 5 and the detected i-th symbol is divided by the gain of the MIMO-detected symbol, a symbol expressed as Equation 6 is detected.

$${s}_{i}^{′} = {s}_{i} + {\sum }_{j = 1}^{{N}_{T}} {\overline{h}}_{ij} {n}_{j} \qquad ( Equation 6 )$$

A variance value of noise may be calculated as expressed by Equation 7.

$${\hat{σ}}_{i}^{2} = {\sum }_{j - 1}^{{N}_{t}} {‖ {\overline{h}}_{ij} ‖}^{2} {σ}_{j}^{2} \qquad ( Equation 7 )$$

The MIMO decoder 410 delivers the detected symbol sᵢ′ and the variance value of noise to the demapper 420.

The demapper 420 may obtain a soft decision value according to the MLD scheme as expressed by Equation 8 by using the symbol sᵢ′ and the variance value of noise.

$$L ( {\hat{b}}_{ij} \vert r ) = log ( \frac{{\sum }_{s : {b}_{i , j} ( s ) = 1} exp ( - \frac{1}{{\sum }_{j = 1}^{{N}_{t}} {‖ {\overline{h}}_{ij} ‖}^{2} {σ}_{j}^{2}} {‖ {\hat{s}}_{i} - s ‖}^{2} )}{{\sum }_{s : {b}_{i , j} ( s ) = 0} exp ( - \frac{1}{{\sum }_{j = 1}^{{N}_{t}} {‖ {\overline{h}}_{ij} ‖}^{2} {σ}_{j}^{2}} {‖ {\hat{s}}_{i} - s ‖}^{2} )} ) \qquad ( Equation 8 )$$

Alternatively, the MIMO decoder 410 may use the MMSE detection scheme and the demapper 420 may use the maximum log map scheme.

When the MIMO decoder 410 uses the MMSE detection scheme, a symbol as expressed by Equation 9 may be detected.

\hat{s}=(H^{H}H+Nₜσ²I)⁻¹H^{H}r (Equation 9)

When H̅=(H^{H}H+Nₜσ²I)⁻¹H^{H}H and \tilde{H}=(H^{H}H+Nₜσ²I)⁻¹H^{H} in Equation 9, Equation 9 may be expressed as Equation 10.

ŝ= H̅s+\tilde{H}n (Equation 10)

The symbol detected according to the MMSE detection scheme may be divided by a channel gain of the corresponding symbol, as expressed by Equation 11.

$${s}_{i}^{′} = \frac{{\hat{s}}_{i}}{{\overline{h}}_{ii}} = {s}_{i} + {\sum }_{j = 1 ( j \neq i )}^{{N}_{T}} \frac{{\overline{h}}_{ij}}{{\overline{h}}_{ii}} {s}_{j} + {\sum }_{j = 1}^{{N}_{T}} \frac{{\tilde{h}}_{ij}}{{\overline{h}}_{ii}} {n }_{j} \qquad ( Equation 11 )$$

A variance value of interference and noise in Equation 11 may be calculated as expressed by Equation 12.

$${\hat{σ}}_{i}^{2} = \frac{{\sum }_{j = 1 ( j \neq i )}^{{N}_{t}} {‖ {\overline{h}}_{ij} ‖}^{2} + {\sum }_{j = 1}^{{N}_{r}} {‖ {\tilde{h}}_{ij} ‖}^{2} {σ}_{i}^{2}}{{‖ {\overline{h}}_{ii} ‖}^{2}} \qquad ( Equation 12 )$$

The MIMO decoder 410 delivers the symbol sᵢ′ detected by Equation 11 and the variance value of interference and noise calculated by Equation 12 to the demapper 420.

The demapper 420 may obtain a soft decision value according to the maximum log map scheme by using the symbol sᵢ′ and the variance value of noise as expressed by Equation 13.

$$L ( {\hat{b}}_{ij} \vert r ) \approx - \frac{1}{\frac{{\sum }_{j = 1 ( j \neq i )}^{{N}_{t}} {‖ {\overline{h}}_{ij} ‖}^{2} + {\sum }_{j = 1}^{{N}_{r}} {‖ {\tilde{h}}_{ij} ‖}^{2} {σ}_{i}^{2}}{{‖ {\overline{h}}_{ii} ‖}^{2}}} [ {max}_{s : {b}_{i , j} ( s ) = 1} {‖ {\hat{s}}_{i} - s ‖}^{2} - {max}_{s : {b}_{i , j} ( s ) = 0} {‖ {\hat{s}}_{i} - s ‖}^{2} ] \qquad ( Equation 13 )$$

Meanwhile, when the demapper 420 uses the soft decision detecting scheme using a hard decision boundary, a soft decision value may be obtained by using the symbol sᵢ′ and the variance value of noise as expressed by Equation 14.

$$L ( {\hat{b}}_{ij} \vert r ) \approx - \frac{2}{\frac{{\sum }_{j = 1 ( j \neq i )}^{{N}_{t}} {‖ {\overline{h}}_{ij} ‖}^{2} + {\sum }_{j = 1}^{{N}_{r}} {‖ {\tilde{h}}_{ij} ‖}^{2} {σ}_{i}^{2}}{{‖ {\overline{h}}_{ii} ‖}^{2}}} 〈 {D}_{i} - s 〉 \qquad ( Equation 14 )$$

Here, Di denotes a hard decision boundary of i-th bit and < > denote operations for obtaining a distance between the hard decision boundary and a reception symbol.

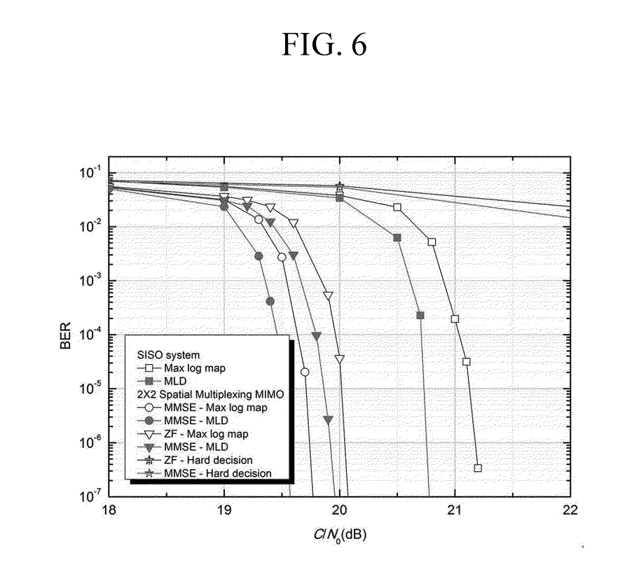

FIG. 6 is a view illustrating bit error rate (BER) performance when the soft decision detecting method according to an exemplary embodiment of the present invention is used. Table 2 shows parameters used for BER performance simulation.

TABLE 2

| Parameters | Specifications |
|---|---|
| Bandwidth | 6 MHz |
| Elementary period | 7/48 μs |
| FFT size | 32K |
| Guard interval | 1/128 |
| Modulation | 256-QAM |
| LDPC code rate | 5/6 |
| Channel model | Timeless Rayleigh fading |
| Cross-polarization discrimination | Inf dB |

In FIG. 6, the BER performance according to “MIMO detection scheme of MIMO decoder 410—demapping scheme of demapper 420” is illustrated, and performance of soft decision detection using hard decision detection is not illustrated. For comparison with the hard decision detection method according to an exemplary embodiment of the present invention, MLD detection performance of the MIMO decoder in the MIMO system needs to be illustrated; however, complexity of MLD detection performance of the MIMO decoder makes it impossible to illustrate the performance thereof, and thus only a performance graph of a SISO system is illustrated.

As illustrated in FIG. 6, it can be seen that BER performance when the soft decision detection method according to an exemplary embodiment of the present invention is used is superior to that of the SISO system.

At least some functions of the soft decision detecting method and apparatus of the multiple-input multiple-output communication system according to an exemplary embodiment of the present invention may be implemented by hardware or may be implemented by software combined with hardware. For example, a processor implemented as a central processing unit (CPU) or any other chip set, a microprocessor, and the like may perform the functions of the MIMO decoder 410 and the demapper 420, and the transceiver may perform functions of the transmission antennas Tx₁-Tx_{N} and the reception antennas Rx₁-Rx_{N}.

According to an exemplary embodiment of the present invention, MIMO detection can be performed through simple calculation.

The embodiments of the present invention may not necessarily be implemented only through the foregoing devices and/or methods, but may also be implemented through a program for realizing functions corresponding to the configurations of the embodiments of the present invention, a recording medium including the program, or the like, and such an implementation may be easily made by a skilled person in the art to which the present invention pertains from the foregoing description of the embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A soft decision detecting method in a multiple-input multiple-output (MIMO) receiving apparatus, the method comprising:
receiving symbols, transmitted through a plurality of transmission antennas, by a plurality of reception antennas;
detecting each reception symbol from signals received through the plurality of reception antennas;
calculating a variance of interference and noise of the detected reception symbols; and
soft-decision-demapping the detected reception symbols by using the variance of interference and noise of the detected reception symbols.

2. The soft decision detecting method of claim 1, wherein
the detecting comprises first detecting symbols by using one among zero forcing (ZF), minimum mean square error (MMSE), and successive interference cancelation (SIC) schemes.

3. The soft decision detecting method of claim 2, wherein
the detecting comprises detecting the reception symbols by dividing the first detected symbols by a corresponding channel gain.

4. The soft decision detecting method of claim 1, wherein
the soft-decision-demapping comprises calculating a soft decision value with respect to the detected reception symbols by using a maximum likelihood detection (MLD) scheme.

5. The soft decision detecting method of claim 1, wherein
the soft-decision-demapping comprises calculating a soft decision value with respect to the detected reception symbols by using a maximum log map scheme.

6. The soft decision detecting method of claim 1, wherein
the soft-decision-demapping comprises calculating soft decision values with respect to the detected reception symbols by using a hard decision boundary.

7. A soft decision detecting device in a multiple-input multiple-output (MIMO) receiving apparatus, the apparatus comprising:
a MIMO demodulation unit configured to detect reception symbols from signals received through a plurality of reception antennas and calculate a variance of interference and noise of the detected reception symbols; and
a demapper configured to soft-decision-demap the detected reception symbols by using the variance of interference and noise of the detected reception symbols.

8. The soft decision detecting device of claim 7, wherein
the MIMO demodulation unit uses one among zero forcing (ZF),
minimum mean square error (MMSE), and successive interference cancelation (SIC) schemes.

9. The soft decision detecting device of claim 8, wherein
the MIMO demodulation unit detects the reception symbols by dividing the symbols detected by the one detection scheme, by a channel gain.

10. The soft decision detecting device of claim 7, wherein
the demapper performs soft-decision-demapping by using one among a maximum likelihood detection (MLD) scheme, a maximum log map scheme, and a scheme using a hard decision boundary.
